(19) United States
(12) Patent Application Publication
(10) Pub. No.: US 2008/0291975 A1
(43) Pub. Date: Nov. 27, 2008

(54) Method for Operating an Enciphered Radio Network

(75) Inventors: Dieter Sorgel, Atlandsberg (DE); Ingo Voll, Wustermark (DE)

Correspondence Address: DITTHAVONG MORI & STEINER, P.C., 918 Prince St., Alexandria, VA, 22314, US

(73) Assignee: Rohde & Schwarz SIT GmbH, Berlin (DE)

(21) Appl. No.: 11/632,282

(22) PCT Filed: Jun. 3, 2005
(86) PCT No.: PCT/EP2005/006006

§ 371 Date: Jan. 17, 2008

(30) Foreign Application Priority Data
Jul. 12, 2004 (DE) 10 2004 033 610.5

(51) Int. Cl. H04B 1/713; H04Q 7/20; H04K 1/00

(52) U.S. Cl. 375/132; 455/450; 380/34; 375/E01.033

(57) ABSTRACT

An approach is provided for operating a radio network, wherein the operating frequency is varied systematically according to an enciphered sudden-frequency-change scheme and retained only during a hop. Several hops are combined to form a service interval, a service window being arranged at a variable position within the service interval. Given hops for different functionalities (late traffic entry, break-in, hailing, late network entry) of the radio network are specified in the service window.

### BACKGROUND

The invention relates to communications, and particularly to operating an enciphered radio network.

Regarding the prior art, reference is made, by way of example, to EP 0 663 737 A2, which discloses a so-called hailing for mobile telephone networks.

### SUMMARY OF THE INVENTION

A need, therefore, exists to provide a method for operating a radio network, in which the operating frequency is varied schematically according to an enciphered sudden-frequency-change scheme, and which guarantees extended functionally, increased operating security, and security against tapping.

The various embodiments of the present invention implement different functionalities of the radio network, in particular, a late traffic entry (LTE) of a radio device into the radio network, if the normal link setup is missed; an interruption of radio operation (break-in) by a radio device of higher priority; or a general (emergency) call (hailing) of any radio device, can be realized by reserving different hops for the various functionalities within a so-called service window. In the present description, a hop is understood to mean the frequency dwell time, during which the operating frequency is held constant, before jumping according to the enciphered sudden-frequency-change scheme to the next operating frequency. The service window is arranged at a variable position within a superordinate service interval. The hops reserved for the various functionalities allow a call by a radio device not yet participating in the radio traffic for late traffic entry, break-in or hailing.

It is advantageous, if the arrangement of the service window within the service interval is varied constantly.

Furthermore, it is advantageous if the length of the service window differs in a traffic mode and in a search mode. In the traffic mode, the service window can contain only a given number of hops, during which a late traffic entry by a radio device not yet participating in the radio traffic is allowed, and another number of hops, during which a break-in can take place.

In a search mode, the service window may then contain additional hops for the general (emergency) call or hailing. In this context, one hop can be provided for a network-wide call (general hailing) and another hop can be provided for a network-specific call (net hailing). In an advanced search mode, further hops can be provided for a late network entry (late net entry), in order to allow a time synchronization of the radio device entering the network with the radio device transmitting the time reference (time reference unit).

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a data-communications system, in accordance with an exemplary embodiment of the present invention;

FIG. 2 is a flowchart of a operating scheme of the data-communications system, according to an exemplary embodiment of the present invention;

FIG. 3A illustrates a structure of an exemplary synchronization hop, in accordance with an embodiment of the present invention;

FIG. 3B illustrates a structure of an exemplary data hop, according to an embodiment of the present invention;

FIG. 4 depicts an exemplary position of a service window within a service interval along with a structure of the service window, according to an exemplary embodiment of the present invention; and

FIG. 5 depicts an exemplary detailed structure of a service window, in accordance with an embodiment of the present invention.

### DESCRIPTION OF THE PREFERRED EMBODIMENT

A system and method for operating a radio network are described. In the following description, for the purposes of explanation, numerous specific details are set forth in order to provide a thorough understanding of the various exemplary embodiments. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

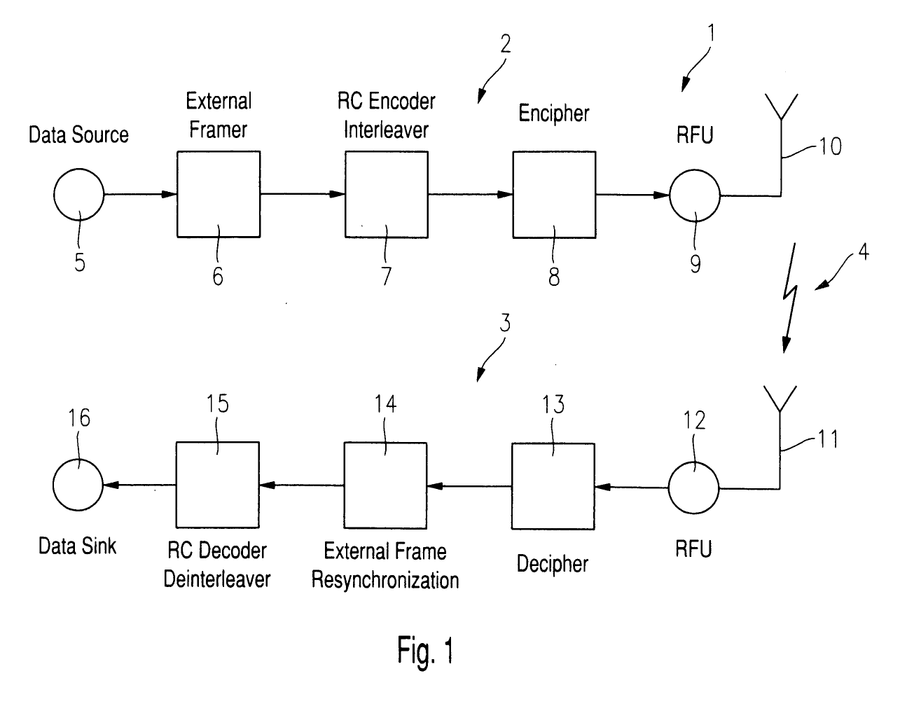

FIG. 1 is a diagram of a data-communications system, in accordance with an exemplary embodiment of the present invention. The depicted radio communications system 1 consists of a transmitter 2 and a receiver 3 with a radio transmission link 4 (radio interface) disposed between them. Each radio device present in the radio communications system 1 typically comprises a combination of transmitter 2 and receiver 3 (transceiver). However, those of ordinary skill in art will readily recognize that pure transmission stations or pure receiver stations can also be present.

The data are supplied from a data source 5 to a framer 6 and then an encoder and interleaver 7. The data are enciphered in a downstream enciphering unit (encipher) 8. Modulation and conditioning in the radio-frequency position takes place in a radio frequency unit (RFU) 9, and the data are transmitted via a transmission antenna 10.

The data are received via a reception antenna 11 and a radio frequency unit 12. Deciphering takes place via a deciphering unit 13. The frames are resynchronized in a resynchronization unit 14 and in a downstream decoder and deinterleaver 15, where the original data stream is restored and supplied to a data sink 16.

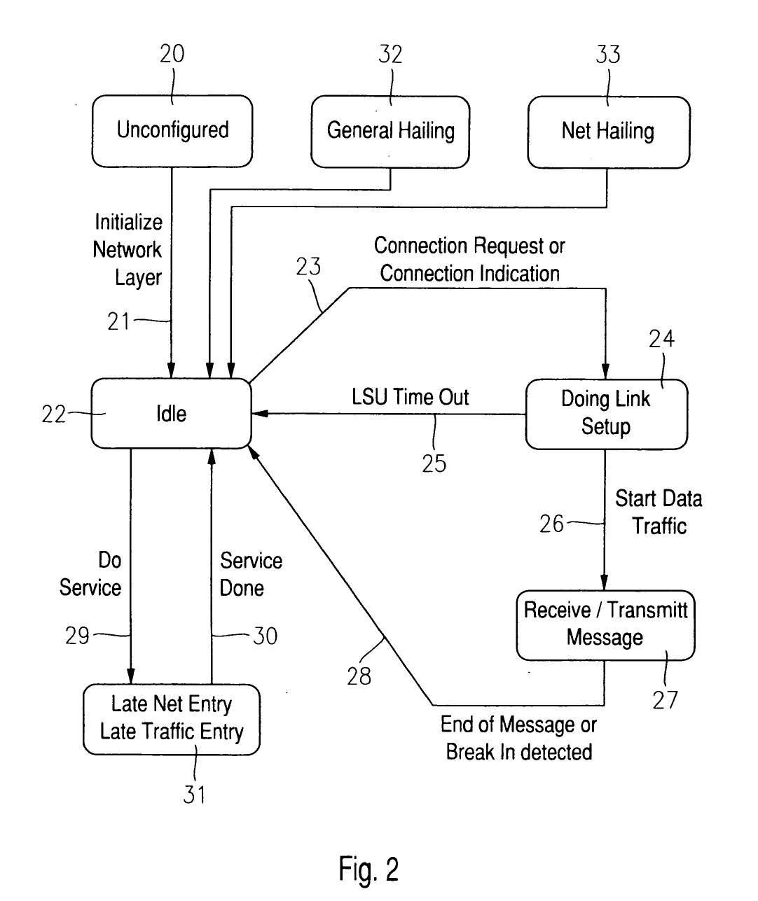

FIG. 2 is a flowchart of an operating scheme of the data-communications system, according to an exemplary embodiment of the present invention.

In a condition 20, the radio devices have not yet been configured. The radio network 1 is initialized by means of an initialization 21. The radio network 1 is then disposed in an idle condition 22. The link setup 24 is started in response to a connection request 23. A maximum link setup time is allowed for this purpose. When this time has elapsed, the LSU time out 25 is detected, and the system returns to the idle condition 22. If the link setup is successful, the data traffic is started in condition 26 (start data traffic), so that the messages can be received and transmitted in condition 27, either until the end of the message (end of message) is reached, or until an interruption (break-in) by a radio device of higher priority is detected, and the system returns to the idle condition 22 in stage 28.

A late traffic entry into an already-existing connection, if the normal link setup has been missed, or a late network entry (late net entry) of a radio device into the already-initialized radio network is additionally possible. The request “do service” is provided for this purpose in stage 29, to which the reply is “service done” in stage 30, after the late traffic entry of the late net entry has been implemented in condition 31.

A general call (hailing), which is used primarily in emergency mode as an emergency call, is also possible. In this context, a distinction is made between a network-wide call (general hailing) 32 and a network-specific call (net hailing) 33.

A method according to an embodiment of the present invention for operating the radio network functions according to the so-called sudden-frequency-change method, that is to say, the operating frequency is changed constantly and systematically according to an enciphered frequency-change scheme and retained only during a so-called hop, that is to say, during a defined frequency dwell time. In this context, a distinction is made between synchronization hops (SYNCH hop) and data hops (DATA hop).

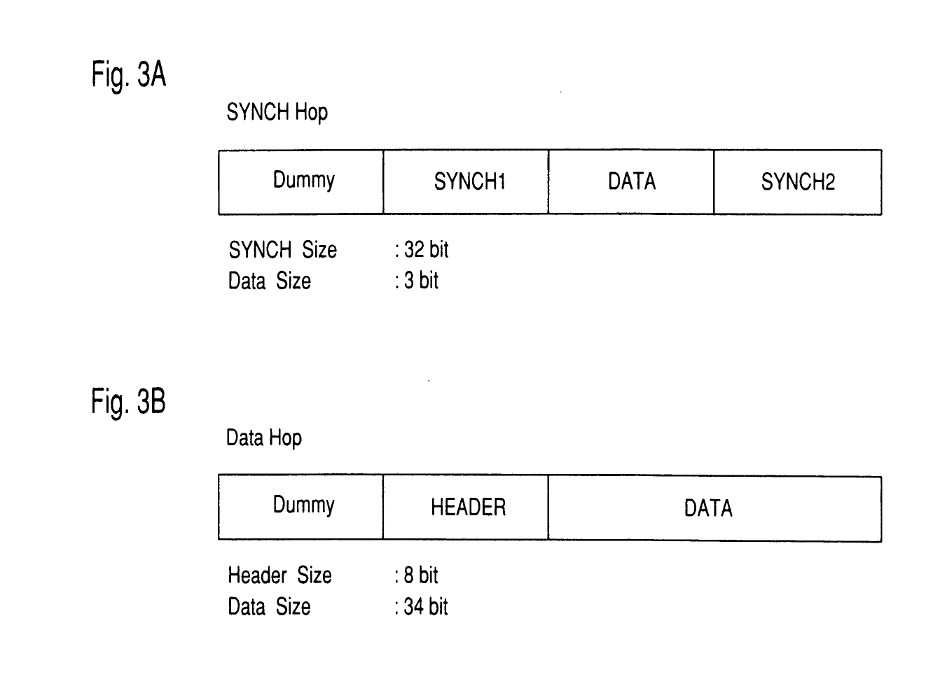

FIG. 3A illustrates a structure of an exemplary synchronization hop, in accordance with an embodiment of the present invention. A few dummy bits are initially transmitted; these are followed by the transmission of a plurality of pre-determined synchronization bits in two synchronization-bit fields SYNCH 1 and SYNCH 2. In the illustrated embodiment, the length of the synchronization-bit fields is 32 bits, while the length of a short data field DATA, which is arranged between the two synchronization-bit fields, is only 3 bits.

FIG. 3B illustrates a structure of an exemplary data hop, according to an embodiment of the present invention. Here also, a few dummy bits are initially transmitted, followed by a few header bits in a HEADER field 8 bits long and then followed by a data field, in the example, 34 bits long.

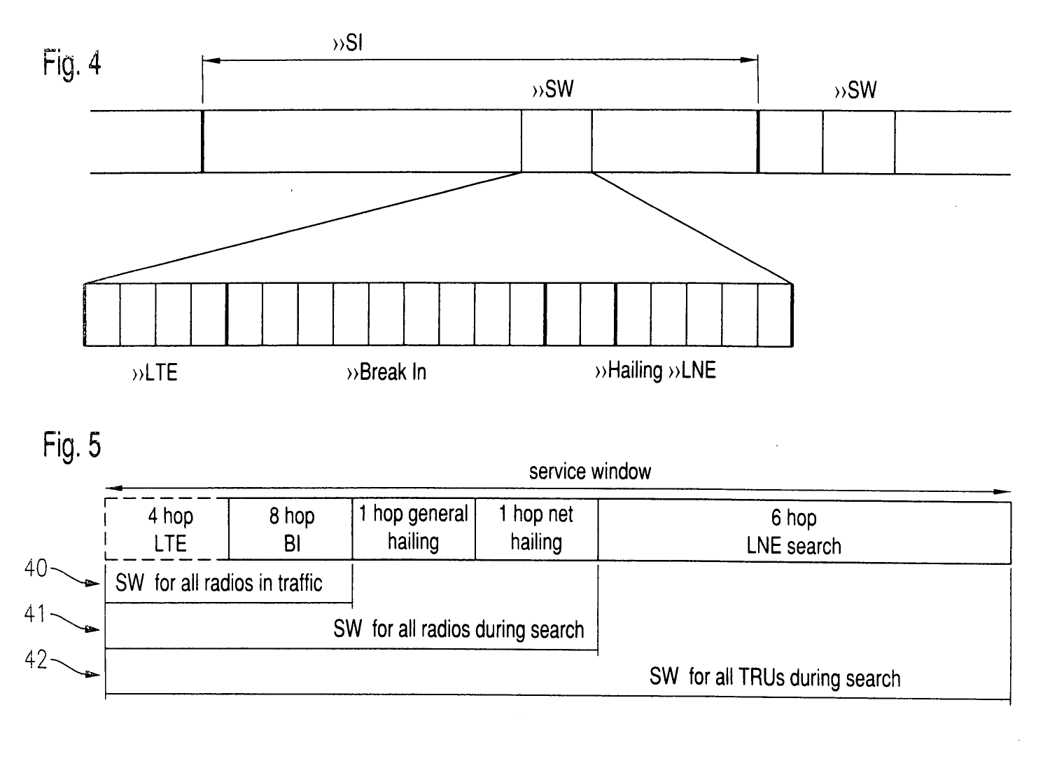

FIG. 4 depicts an exemplary position of a service window within a service interval along with a structure of the service window, according to an exemplary embodiment of the present invention. The transmission takes place, for example, at a rate of 512 hops per second. One hundred fifty hops form a so-called service interval SI, which, in this example, has a length of 293 ms. Each service interval SI comprises a link setup window and a so-called service window SW. The functionalities of the radio network, namely late traffic entry, late net entry, break-in and hailing, as described with reference to FIG. 2, are made possible via the service window. For this purpose, the structure and definition of the hops included in the service window are as shown in the lower part of FIG. 4 and in FIG. 5. The service window is preferably transmitted in every service interval SI at a different position corresponding to the enciphering algorithm, which is indicated in FIG. 4. Constantly changing the position of the service interval additionally hinders a tapping of the radio network.

FIG. 5 depicts an exemplary detailed structure of a service window, in accordance with an embodiment of the present invention. As shown in FIG. 5, the service window SW preferably has three different lengths. In a traffic mode 40, the service window SW consists of four hops for the late traffic entry (late traffic entry) and 8 eight hops for the interruption of radio operation (break-in). The traffic mode is used during a current connection (logical link), in order to keep the service window as short as possible and to provide as large a time window as possible for the data transmission. The late traffic entry means that radio devices, which have missed the link setup, can still enter a connection (logical link). The radio device, which wishes to make use of the late-traffic-entry function, transmits a corresponding request and synchronization data during the first four hops of the service window. The other radio devices, which are disposed either in the traffic mode or in one of the two search modes 41 or 42 still to be described, monitor the first four hops of the service window SW to determine whether a radio device is transmitting a request for a late traffic entry. If this is the case, an attempt will be made to receive the late-traffic-entry synchronization data and to set up a link.

Break-in is used to interrupt an existing connection (physical link). A radio device, which triggers a break-in, transmits a corresponding request consisting of break-in request information and break-in synchronization information on the eight hops provided for this purpose. In this context, the network address of the radio device, whose operation is to be interrupted, and the priority of the requesting radio device are transmitted. The other radio devices monitor the hops provided in every service window for the break-in, they interrupt their radio operation in the event of a break-in with adequate priority and then participate in the link setup with the radio device requesting the break-in. In the illustrated embodiment, the eight hops for the break-in are disposed after the four hops for the late traffic entry.

Radio devices, which are not connected to other radio devices, use the search mode 41. The service window SE in this case is expanded by one hop for a network-wide general call (general hailing) and respectively one hop for a network-specific general call (net hailing). Hailing is used primarily to allow an emergency call. By contrast with the other hop frequencies, the frequencies for the general-hailing hop and the net-hailing hop are not changed from service interval to service interval, but always remain constant. Accordingly, radio devices, which do not have the enciphering algorithm for the hop frequencies at their disposal, can also place an emergency call on the general-hailing frequency and the net-hailing frequency.

A radio device with a time reference is present in the radio network. This radio device (TRU, time reference unit) uses the advanced search mode 40, wherein the two hops for the hailing are followed by six additional hops for the late net entry. The radio device, which wishes to gain access to the network and requires the time reference for synchronization, transmits a corresponding request to the time reference unit, which is answered by the time reference unit.

While the present invention has been described in connection with a number of embodiments and implementations, the present invention is not so limited but covers various obvious modifications and equivalent arrangements, which fall within the purview of the appended claims.

1. A method for operating a radio network, comprising:
systematically varying an operating frequency according to an enciphered sudden-frequency-change scheme; and
only retaining the operating frequency during a hop,
wherein a plurality of hops are combined to form a service interval, wherein a service window is arranged at a variable position within the service interval and wherein given hops within the service window are specified for at least one of the following functionalities of the radio network:
late traffic entry of a radio device into the radio network, if the normal link setup has been missed,
interruption of radio operation by a radio device with higher priority, and/or
general call by any radio device.

2. The method according to claim 1, wherein the arrangement of the service window in the service interval is varied constantly.

3. The method according to claim 1, wherein the service window comprises a different length and a different number of hops in a traffic mode and in a search mode.

4. The method according to claim 3, wherein in the traffic mode, the service window contains a pre-defined number of hops for the late traffic entry and a pre-defined number of hops for the break-in.

5. The method according to claim 4, wherein the pre-defined number of hops for the late traffic entry is four, and the pre-defined number of hops for the break-in is eight.

6. The method according to claim 4, wherein the hops for the late traffic entry are arranged before the hops before the break-in.

7. The method according to claim 3, wherein in a normal search mode, the service window contains at least one additional hop for the general call.

8. The method according to claim 7, wherein one hop is provided for a network-wide general call and one hop is provided for a network-specific general call.

9. The method according to claim 8, wherein the hops for the general call are arranged after the hops for the late traffic entry and the hops for the break-in.

10. The method according to claim 7, wherein in an advanced search mode, the service window contains an additional hop for late net entry.

11. The method according to claim 10, wherein the advanced search mode is used only by a radio device with a time reference unit.
